(19) United States
(12) Patent Application Publication
(10) Pub. No.: US 2015/0257247 A1
(43) Pub. Date: Sep. 10, 2015

(54) INJECTOR DESIGN USING COMBINED FUNCTION, MULTIPLE CAVITIES FOR SIX DIMENSIONAL PHASE SPACE PRESERVATION OF PARTICLE BUNCHES

(71) Applicant: JEFFERSON SCIENCE ASSOCIATES, LLC, Newport News, VA (US)

(72) Inventor: Fay Hannon, Poquoson, VA (US)

(21) Appl. No.: 14/638,319

(22) Filed: Mar. 4, 2015

Related U.S. Application Data
(60) Provisional application No. 61/950,142, filed on Mar. 9, 2014.

(51) Int. Cl. H05H 7/00; H05H 7/02

(52) U.S. Cl. CPC H05H 7/001; H05H 7/02; H05H 2007/007; H05H 2007/025

(57) ABSTRACT

An injector design using a plurality of combined function cavities for six-dimensional phase space preservation of particle bunches. The combined function cavities are shaped optimally to account for phase-slippage, and operated at a phase such that a combination of acceleration and bunching occurs simultaneously, in proportion to one another, so that the 6D phase space doesn't expand.

This application claims the priority of Provisional U.S. Patent Application Ser. No. 61/950,142 filed Mar. 9, 2014.

The United States Government may have certain rights to this invention under Management and Operating Contract No. DE-AC05-06OR23177 from the Department of Energy.

### FIELD OF THE INVENTION

The present invention relates to particle beams and more particularly to a method for preserving the 6D brightness of highly space-charge dominated beams.

### BACKGROUND

In particle accelerators, the motion of particle bunches at low energy is typically dominated by space-charge effects. For space-charge dominated particle beams (e.g. as found in injectors), it is not possible to operate particle accelerators in conventional ways to fully preserve the six-dimensional (6D) brightness of the bunch.

Typically, radio frequency (RF) structures are used to either bunch or accelerate the particle bunches independently, which modifies (to the 1^{St} order) 2D longitudinal phase space or 4D transverse phase space respectively. In order to preserve the 6D brightness of highly space-charge dominated beams, RF cavities must be operated in a way such that both bunching and acceleration occur simultaneously and optimally in such a manner that brightness is not destroyed. This process can be repeated in subsequent cavities with varying degrees of bunching/accelerating until the bunch is no longer space-charge dominated. The geometry, gradient and phase of the cavities are all required to optimally preserve bunch brightness and approach the brightness limit.

Accordingly, it would be advantageous to provide a method for operating RF cavities in such a manner that bunching and acceleration occur simultaneously and the six-dimensional brightness of the bunch is preserved.

### OBJECT OF THE INVENTION

The object of the present invention is to provide a method for preserving the 6D brightness of highly space-charge dominated charged particle beams.

A further object is to provide a method for operating RF cavities in a way such that both bunching and acceleration occur simultaneously and optimally in such a manner that brightness is not destroyed and thereafter repeating this process in subsequent cavities with varying degrees of bunching/accelerating until the bunch is no longer space-charge dominated.

### SUMMARY OF THE INVENTION

The present invention provides a method for preserving the six-dimensional (6D) brightness of highly space-charge dominated charged particle beam using combined function, multiple cavities for six dimensional phase space preservation of particle cavities. The number of cavities required to accelerate the bunch to a non space-charge dominated regime depends both on the bunch charge and the initial kinetic energy of the bunch. Lower charge and higher energy will both result in fewer combined function cavities. A non space-charge dominated bunch is said to be emittance dominated. This invention is applicable to all types of charged particles that can be accelerated by standard RF cavities. As an example, five accelerator cavities are used to achieve an emittance dominated and relativistic electron bunch in an injector. The first four cavities use a combination of accelerating and bunching to maintain bunch brightness. The last cavity is operated to only accelerate the electrons.

For six-dimensional phase space preservation, the cavities are operated at between −90 and 0 degrees of the sinusoid of phase (as shown in FIG. 1), to enable bunching and accelerating to happen simultaneously, in proportion to one another so that the 6D phase space doesn't expand.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a plot schematically depicting the sinusoid of RF gradient versus phase in an RF accelerator structure. Zero degrees phase is defined as that at which maximum energy gain of the particle bunch occurs. Phase values of −90 and +90 degrees correspond to no energy gain.

FIG. 2 depicts an example from a simulation that uses five cavities to achieve a relativistic, emittance dominated electron beam.

### DETAILED DESCRIPTION

When the motion of particle bunches are severely space-charge dominated, it is no longer possible to use standard accelerator components in conventional ways to preserve the six-dimensional brightness of the bunch. Typically, RF structures are used to either bunch or accelerate the particle bunches independently, which modifies (to the 1^{St} order) 2D longitudinal phase space or 4D transverse phase space respectively. In order to preserve the 6D brightness of highly space-charge dominated beams, RF cavities must be operated in a way such that both bunching and acceleration occur simultaneously and optimally so brightness is not destroyed. This process can be repeated in subsequent cavities with varying degrees of bunching/accelerating until the bunch is no longer space-charge dominated. The geometry, gradient and phase of the cavities are all required to optimally preserve bunch brightness and approach the brightness limit.

The six-dimensional phase space preservation method of the present invention can be used in any scenario where space-charge is severe in a particle accelerator. Typically, this is when the particle source can't deliver fully relativistic bunches in injectors. For example, DC electron guns with low exit energy (few keV) or moderate (few MeV) energy guns in high charge operation.

Rather than designing RF cavities that either bunch or accelerate, the six-dimensional phase space preservation method uses cavities that can do both optimally. In conventional injectors, the action of bunching and accelerating are separate for ease of operation, cost, and historically because 6D brightness has not been pushed to theoretical limits. For these cavities to work optimally, transit time of the incident charged particle bunch must be considered in designing the shape of the cavity, such that bunching and acceleration happens efficiently in each. Conventional techniques try to avoid the space-charge dominated regime with higher injection energies.

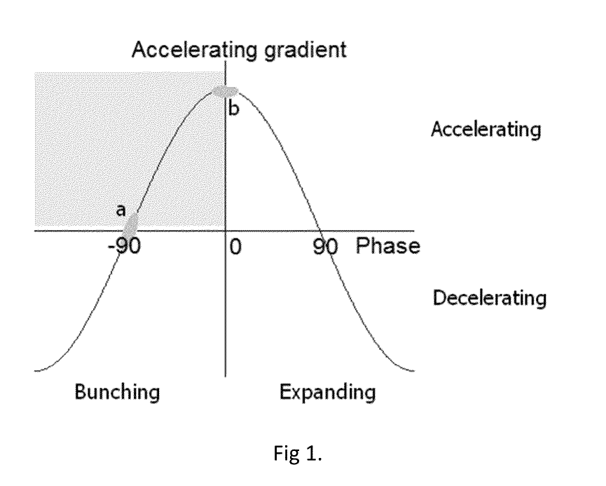

Brightness is the bunch charge per unit volume of the bunch, essentially charge over 6D phase space. With reference to FIG. 1, charged particle bunches are typically placed at position (a) for bunching (no energy gain) or (b) for accelerating (no bunching). In practice, the bunches have a finite length and transit the cavity at less than the speed of light, so often there is phase slippage in cavities, so some acceleration/deceleration/bunching/expanding happens by nature. Conventional accelerating cavities are typically operated between around +/−20 degrees to avoid imposing the RF curvature of the sinusoid on the bunch. Depending on the length and energy of the bunch, there may be bunching or expansion as a consequence.

For six-dimensional phase space preservation according to the present invention, operation would be purposefully in the upper left quadrant of FIG. 1 such that bunching and accelerating happen simultaneously, in proportion to one another so that the 6D phase space doesn't increase. Over-bunching longitudinally, while non-relativistic, will cause the normalized transverse 4D (and therefore 6D) phase space to expand. Also the transverse focusing electric fields in the cavity, which are at a maximum at 0 degrees (i.e. at maximum accelerating phase), can cause the longitudinal phase space to expand if the bunch is over-focused transversely. So one can see that there is a trade-off between the two functions, and combining them is more optimal than having them separate. This becomes more important with space charge dominated beams, as the non-linear forces cause irretrievable brightness degradation.

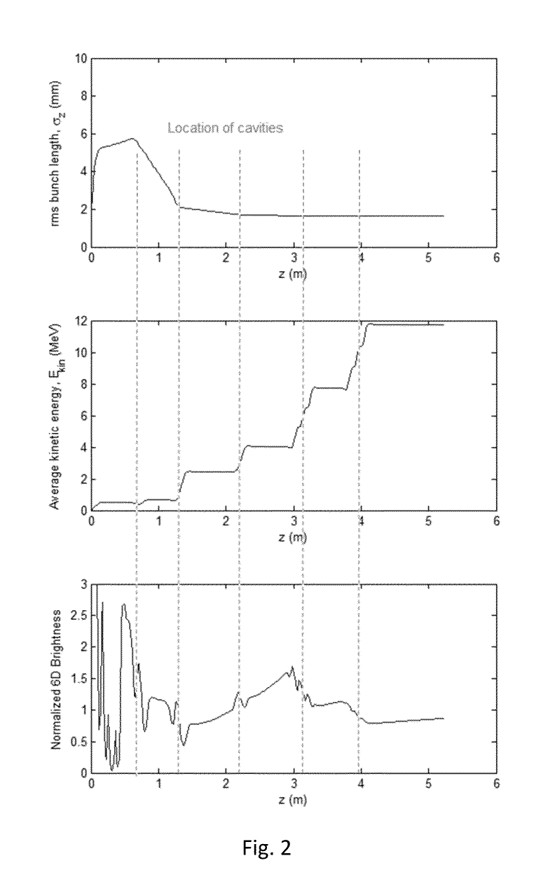

With reference to FIG. 2, there is shown an example from a simulation that uses 5 cavities (of varying number of cells) to get an electron beam emittance-dominated and relativistic. The first 4 cavities use a combination of accelerating and bunching to maintain beam brightness. Velocity bunching with cavities becomes increasingly ineffective at higher electron bunch energies. The last cavity in this example only accelerates. This set up isn't optimal as there is some phase slippage in the cavities as the length has not been optimized.

For a particular layout such as shown in FIG. 2, to approach the 6D beam parameters desired, the first 4 cavities had to bunch as well as accelerate as there was no dedicated buncher cavity. The amount of bunching decreases while the amount of acceleration increases as the bunch encounters each cavity in order from the particle source. For ultimate brightness, multiple cavities must be used in a bunching/accelerating combination until the beam is relativistic and emittance dominated.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for preserving the six-dimensional (6D) brightness of highly space-charge dominated charged particle beams, comprising:
a. providing a plurality of initial radio frequency (RF) cavities to accelerate the particle beam to relativistic speed; and
b. operating the initial accelerator cavities to simultaneously accelerate and bunch the charged particles to maintain beam brightness;

2. The method of claim 1, which includes operating the initial RF cavities at a phase to enable bunching and accelerating to occur simultaneously, in proportion to one another, in order to prevent the 6D phase space from expanding.
